(19) United States
(12) Patent Application Publication
(10) Pub. No.: US 2019/0244131 A1
(43) Pub. Date: Aug. 8, 2019

(54) METHOD AND SYSTEM FOR APPLYING MACHINE LEARNING APPROACH TO ROUTING WEBPAGE TRAFFIC BASED ON VISITOR ATTRIBUTES

(71) Applicant: Unbounce Marketing Solutions Incorporated, Vancouver (CA)

(72) Inventors: Thomas Scott LEVI, Vancouver (CA); Jordan Tyler DAWE, Vancouver (CA); Yosem Simon REICHERT-SWEET, RICHMOND (CA); Michael Brendan McDERMOTT, Vancouver (CA)

(21) Appl. No.: 16/265,142

(22) Filed: Feb. 1, 2019

Related U.S. Application Data
(60) Provisional application No. 62/625,713, filed on Feb. 2, 2018.

(51) Int. Cl. G06N 20/00; G06N 7/00; G06N 5/04

(52) U.S. Cl. CPC G06N 20/00; G06N 5/04; G06N 7/005

(57) ABSTRACT

The present invention is a cloud-based machine learning method and system that utilizes the attributes and past performance statistics of visitors to a set of webpage variants to predict performance statistics for incoming website visitors with respect to the webpage variants, and uses such predicted performance statistics to direct such incoming website visitors; and which learns from the performance of each directed website visitor by refining the past performance statistics to take into account such performance and the attributes of each directed website visitor, all in order to optimize future performance statistics for the set of webpage variants.

### CROSS-REFERENCE TO RELATED APPLICATIONS

This patent application claims the benefit of and priority to U.S. Provisional Patent Application Ser. No. 62/625,713, filed Feb. 2, 2018, entitled “METHOD AND SYSTEM FOR APPLYING A MACHINE LEARNING APPROACH TO ROUTING WEBPAGE TRAFFIC BASED ON VISITOR ATTRIBUTES,” the contents of which are hereby incorporated by reference in their entirety.

### FIELD OF THE INVENTION

The present invention relates to the fields of applied machine learning and online marketing optimization. More particularly, the present invention relates to the technical field of applied machine learning for marketing optimization regarding webpages.

### BACKGROUND OF THE INVENTION

When marketers create webpages (which can include landing pages, homepages, etc.) for online marketing purposes, for example for a client's online marketing campaign, marketers may create multiple versions of a particular webpage (each version or variant being similar or related to, albeit slightly different from, each other, sometimes referred to herein as webpage variants). Each webpage variant may be geared towards specific types of incoming visitors, and therefore may be expected to “perform” slightly better for its expected visitor type. Webpage performance in the present context may include one or more of a number of measurable parameters, such as conversion rates (“click-throughs”, or lead generations, for example), user time spent on the webpage, monetary value of click-through activities, etc. In the case of online marketing campaigns, the number and extent of “click-throughs” and lead generations are typically of particular interest, and we shall discuss and illustrate the present invention in such a context, although it should be appreciated that this can encompass and be applied to other parameters. The marketers may include specific targeting rules based on any known properties or characteristics of the incoming visitors; however, at present, these rules must be set and defined manually. For example, a specific targeting rule may be: “send all mobile traffic to a webpage variant X” (e.g. which may be a webpage that is better optimized for mobile use or mobile users) or “send all French language traffic to a webpage variant Y”, etc. Currently, there is no system to automate and optimize the targeting based on attributes of the incoming visitor to the online marketing campaign and which is able to learn from such targeting.

### SUMMARY OF THE INVENTION

Disclosed herein is a cloud-based, machine learning computer-implemented method and system that can dynamically route web traffic to the webpage most likely to perform well for a particular visitor (who has certain known attributes), based upon the performance history of the webpage with other visitors having similar such attributes. The method and system of the present invention may be thought of as three modules or components, which are referred to herein as the “predictor”, the “learner” and the “router”.

The predictor module or “predictor” is a general machine learning/artificial intelligence framework capable of estimating, for a marketer's set of webpage variants, the underlying performance statistic that the marketer wishes to optimize (e.g. conversion rates), as well as the uncertainties in said performance statistic, based on the attributes of the visitor to the website. The data used by the predictor may include: one or more known attributes of the visitor, which of the customer's webpage variants each visitor was directed to, and whether or not the visitor was “converted”. The attributes may include but are not limited to: device properties (e.g. operating system type, desktop/mobile, browser used), IP address, internet service provider, user or server geographic location, user demographic and firmographic information, language, referrer channel, and various self-reported tagging codes which may be used on the online marketing campaign (e.g. Urchin Tracking Module (UTM) campaign codes). The predictor algorithm assigns a predicted conversion rate and an associated uncertainty, to each webpage variant for each attribute combination. The predicted performance statistic for each webpage variant, and the associated uncertainty therefor, are based at least in part on the “performance history” in relation to each webpage variant, according to past visitors' attributes (in other words, the performance statistic data that is known or has been collected in respect of each webpage variant, based upon attributes of past visitors). The predicted performance statistics and associated uncertainties for each webpage variant and attribute combination are then passed to the router step.

The router module or “router” is a processing step that uses the statistical estimates of webpage performance generated by the predictor to “decide” which specific webpage variant a visitor should be directed to, based upon the attributes of the visitor. The router balances two competing priorities, “explore” and “exploit”. Given the predicted performance for the webpage variants, the router can direct the visitor to the estimated best webpage variant to maximize the performance statistic, thereby exploiting the best strategy. However, the predictive model does not have perfect information, so the router may still explore other webpage variants to direct the visitor to, thereby reducing uncertainty in future predictions made by the predictor.

In the learner module or “learner”, the performance outcome for the webpage variant that the visitor was directed to is tracked. This information is then added to the performance history. This updated performance history in turn may be used when predicting performance predictions for the next visitor. As more information is added to the performance history, this serves to refine the predicted performance statistic.

Also disclosed herein is a computing device, comprising a display, an internal memory and a processor coupled to the display and the internal memory, wherein the processor is configured with processor-executable instructions to perform operations comprising the method discussed above. Also contemplated herein is a communication system, comprising a plurality of computing devices coupled to a communication network, and a server coupled to the communication network, wherein the server comprises a processor configured with executable instructions to perform operations comprising the method discussed above. Further contemplated is a non-transitory computer readable storage medium having stored thereon processor-executable instructions configured to cause a processor to perform operations comprising the above discussed method.

### BRIEF DESCRIPTION OF THE DRAWINGS

FIG. 1 is a simplified diagram representing a computer system on which embodiments of the present invention may be implemented.

FIG. 2 is a flowchart illustrating the overall process of an embodiment of the present invention.

FIG. 3 is a simplified diagram illustrating the process of the predictor component.

FIG. 4 is a simplified diagram illustrating the process of the router component.

FIG. 5 is a simplified diagram illustrating the process of the learner component.

### DETAILED DESCRIPTION OF THE INVENTION

A detailed description of one or more embodiments of the present invention is provided below along with accompanying figures that illustrate the principles of the invention. As such, this detailed description illustrates the present invention by way of example and not by way of limitation. The description will clearly enable one skilled in the art to make and use the invention, and describes several embodiments, adaptations, variations and alternatives and uses of the invention, including what is presently believed to be the best mode and preferred embodiment for carrying out the invention. It is to be understood that routine variations and adaptations can be made to the invention as described, and such variations and adaptations squarely fall within the spirit and scope of the invention. For the purpose of clarity, technical material that is known in the technical fields related to the invention has not been described in detail so that the invention is not unnecessarily obscured.

The term “computer” can refer to any apparatus that is capable of accepting a structured input, processing the structured input according to prescribed rules, and producing results of the processing as output. Examples of a computer include: a computer; a general purpose computer; a laptop computer; a computer on a smartphone or other portable device, a supercomputer; a mainframe; a super mini-computer; a mini-computer; a workstation; a micro-computer; a server; an interactive television; a hybrid combination of a computer and an interactive television; and application-specific hardware to emulate a computer and/or software. A computer can have a single processor or multiple processors, which can operate in parallel and/or not in parallel. A computer also refers to two or more computers connected together via a network for transmitting or receiving information between the computers. An example of such a computer includes a distributed computer system for processing information via computers linked by a network.

The term “computer-readable medium” may refer to any storage device used for storing data accessible by a computer, as well as any other means for providing access to data by a computer. Examples of a storage-device-type computer-readable medium include: a magnetic hard disk; a floppy disk; an optical disk, such as a CD-ROM and a DVD; a magnetic tape; or a memory chip.

The term “software” can refer to prescribed rules to operate a computer. Examples of software include: software; code segments; instructions; computer programs; and programmed logic.

The term a “computer system” may refer to a system having a computer, where the computer comprises a computer-readable medium embodying software to operate the computer.

Cloud computing, as used herein, refers to anything that involves delivering hosted services over the Internet. The term “cloud” often refers to the Internet, more precisely to one or more datacenters comprised of servers connected to the Internet. A cloud can be a wide area network (WAN) like the Internet or a private, national, or global network. The term can also refer to a local area network (LAN) within an organization. As used herein, a “cloud” is any communications network.

Referring now to the invention in more detail, it consists of a method and system for marketing optimization in the fields of online supervised learning and contextual bandits, comprising a predictive model (the “predictor”), a webpage visitor router (the “router”) and an online supervised model learner (the “learner”). (Although the method and system of the present invention is presented as comprising three separate such modules for ease of illustration, it is to be understood that such modules may also be integrated together within a single system).

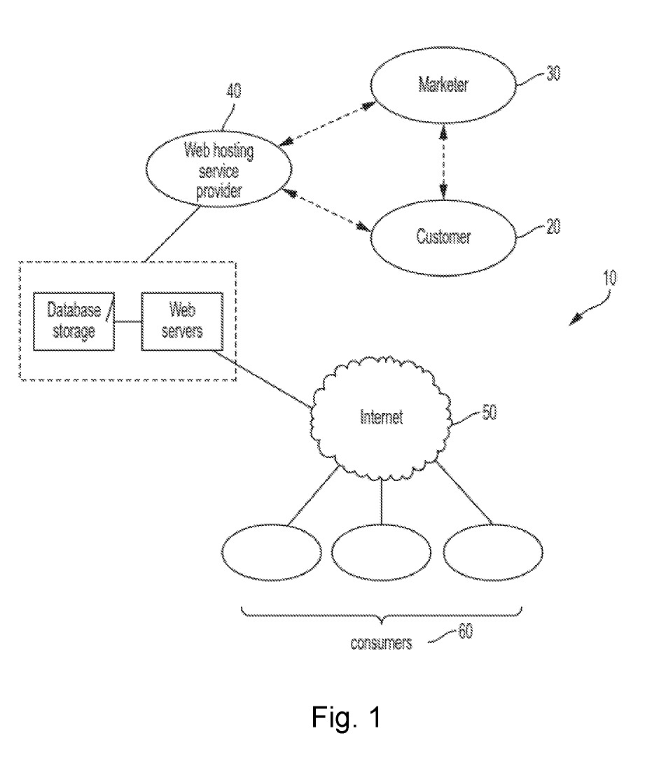

FIG. 1 is a simplified representation illustrating the operation of a conventional webpage hosting service 10, in conjunction with which an aspect of the present invention may be implemented. A customer 20 wishing to promote its products/services by way of an online marketing campaign, engages an online marketer 30, which may handle various aspects of the online marketing campaign, for example, such as webpage creation and management, generating internet traffic to such webpages, lead generation and follow-up, monitoring performance/effectiveness of such activities, etc. The created webpages are hosted (which may involve, for example, dedicated hosting or shared hosting) by a web hosting service provider 40, and made available to potential consumers (visitors) 60 via the Internet 50 when such consumers are directed to visit the customer's webpages. Although the online marketer 30 is shown in FIG. 1 as separate from the web hosting service provider 40, it is contemplated that the web hosting service provider 40 may actually provide the online marketing/webpage service to the customer 20. Although not explicitly shown as such, it should be understood that the interactions and communications between the customer 20, marketer 30 and the web hosting service provider 40 typically will occur via the Internet or other communications network (although they can also occur in-person or by telephone, for example).

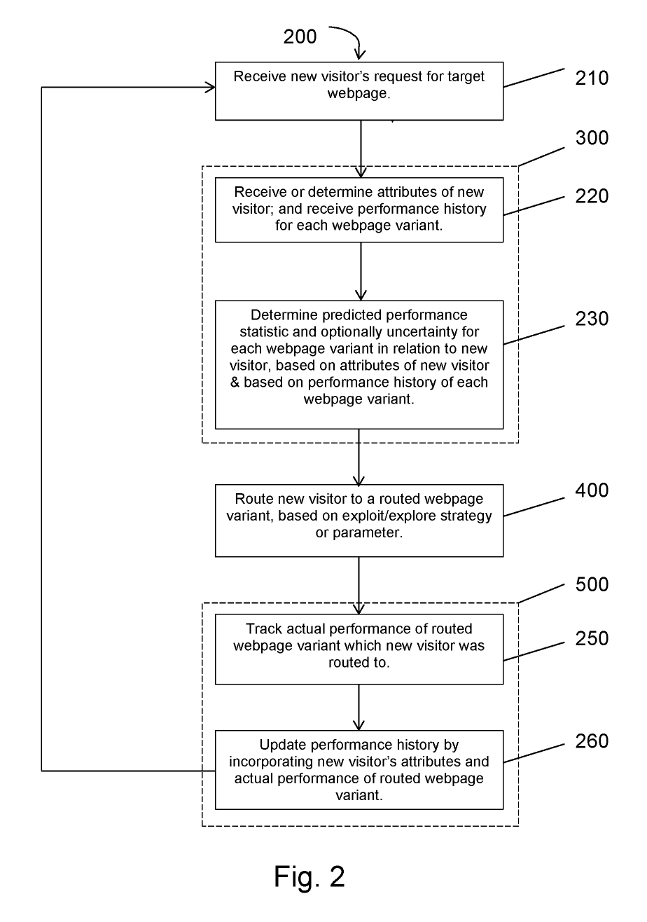

FIG. 2 is a flowchart illustrating the overall process of the present invention. The specific processing steps are discussed in greater detail later, but are summarised here for purposes of explanation. A summary of the processing flow 200 for the system is shown, as a new online visitor 60, i.e. a potential consumer for an online marketing campaign, is directed to, or makes a request for, a target webpage (step 210). The target webpage has a number of webpage variants that have been created in respect thereof. The system receives information regarding certain attributes of the new visitor (step 220). These attributes of the new visitor may be automatically determined/detected by the system, or may have been provided elsewhere (e.g. the new visitor may have expressly input/indicated such information and/or consented to have such information provided/collected). The next processing step (step 230) involves the “predictor” or predictor module (which is discussed in greater detail below). The predictor utilises a predictive model provided by the learner module (detailed below) to predict performance statistics for each webpage variant in relation to the new visitor, based on the attributes of the new visitor and the known performance history of each webpage variant. Steps 220 and 230 are shown together as the processing flow 300 of the predictor.

In the following processing step, referred to herein as the “router” (step 400), the visitor is directed to an appropriate webpage variant (“routed webpage variant”) according to a contextual bandit style consideration of whether to “exploit” or “explore” in respect of such visitor.

The performance of the routed webpage variant with respect to the new visitor is tracked by the system (i.e. to track whether the new visitor was “converted”, after being directed to the routed webpage variant) (step 250). The tracked performance information, as well as the visitor's attributes, is then added to the performance history (step 260) to improve the predictive model used by the predictor module for subsequent website visitors. Steps 250 and 260 are shown together as the processing flow 500 of the learner.

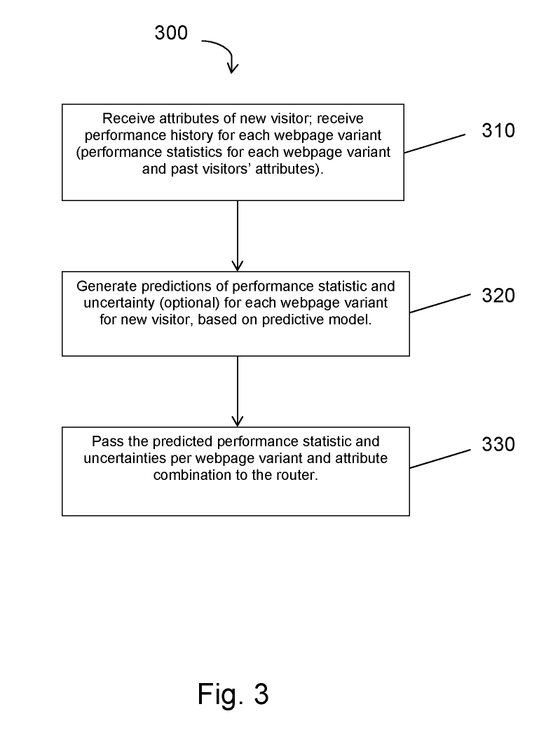

Referring now to the “predictor” in more detail, it consists of a machine learning model that learns and makes predictions for each individual webpage variant, utilizing a general framework. FIG. 3 is a flowchart illustrating the overall processing flow 300 for the predictor. The predictor receives one or more attributes of a new visitor (step 310). Visitor attributes may include, but are not limited to, one or more of: device properties (e.g. operating system type, desktop/mobile, browser used, screen viewpoint size and resolution), IP address, internet service provider, user or server geographic location, user demographic and firmographic information, browser language settings, referrer channel, and various self-reported tagging codes used on the online marketing campaign (e.g. UTM campaign codes). The predictor uses the attributes as inputs to a model (previously generated by the learner module as described below) which makes predictions of the likelihood of future visitors to have a desired performance outcome for each webpage variant and optionally of the uncertainties in these predictions (step 320). The uncertainty may be thought of as a sort of margin of error or confidence level and may be returned as a best guess average value with a specified confidence interval/band around it (for example, a 3% best estimate for the webpage variant's conversion rate with a 95% chance that the subsequently measured conversion rate will fall within the 2%-4% range). It should be understood that accounting for the uncertainty is preferable, but optional, since it is contemplated that in practice the method will nevertheless work if the uncertainty is not taken into account.

Predictions may be made using composite attribute groupings in order to maximize data coverage of groupings, which reduces prediction uncertainties. These composite attribute groupings may be chosen or learned by the learner module. Chosen composite attribute groupings may include, but are not limited to, device grouping and location grouping. These composite attribute groupings are combined to obtain category attributes for a particular visitor. For example, the algorithm may use detailed device information to group visitors into either Android™ or iOS™ device types. Once it has these groupings, the algorithm then independently calculates conversion rates for device type and location. The method for combining these groupings may include, but is not limited to, independent combination, weighted combination and/or linear regression.

The methodology for constructing the performance predictions may include one or more modeling techniques known in the art, including, but not limited to, Naive Bayes, Hierarchical Bayes, Neural Networks, Linear Regression, and/or Regression Trees. For example, consider the case of applying a Naive Bayes algorithm which uses a visitor's attributes of “visitor device type” and “location” information to predict the visitor's conversion rate. The algorithm splits the problem into two pieces, calculating the probability that past converting visitors have the new visitor's device type, and similarly for location. For instance, if the device type for a visitor is “mobile” and the visitor's location is “California”, the previous calculation would break into the past number of mobile conversions divided by the total number of conversions, and the past number of California conversions divided by the total number of conversions. These probabilities are then multiplied together and further multiplied by the probability of any visitor to the webpage being converted and divided by the probability of a visitor having a mobile device type and a California location.

The methodology for constructing the uncertainty estimates may include one or more modeling techniques known in the art including, but not limited to, Monte Carlo sampling, bootstrapping, or propagation of uncertainty, etc. For example, to estimate the uncertainty in the prediction via Monte Carlo sampling, the predictor would choose random samples from an estimate of the distribution of the performance statistic's values. This distribution estimate may be made in a variety of ways depending on the characteristics of the performance statistic; if predicting conversion rate, a standard method would be to draw samples from a beta distribution with parameters determined by the previously observed number of visitors who converted and the number who did not convert. The uncertainty in the prediction could then be determined by calculating the standard deviation of the sampled values.

The output of the predictor step is then a predicted value for the performance statistic and optionally an associated uncertainty for each possible attribute combination and webpage variant (step 330). Since the predictor is able to update its predictions for every new visitor to a webpage, it can learn in real time. This is termed an online process.

Referring now to the “router” in more detail, it consists of a contextual bandit algorithm built specifically according to each webpage's data. The “router” can use the data provided by the predictor to decide which webpage variant each visitor should be sent to. The router is configured to balance two goals: exploiting the “good” predicted pages for a given visitor to obtain better performance statistics (i.e. directing the visitor having certain known attributes to webpage variants which are predicted to have good performance statistics for such a visitor, based on the performance history for visitors having similar attributes), and exploring to determine whether other webpage variants may have better performance statistics. At one extreme, the router may be configured so that all web traffic is simply directed to those webpage variants that will maximise the performance (e.g. conversion rates)—i.e. where the “exploit” weighting is 100%; this may be a particularly reasonable option where there is already a considerable amount of good quality performance history data. However, the “explore” option allows for exploration of other webpage variants which may also produce good or better performance, but whose performance may not have been predicted as being good because, for example, there was insufficient performance history data to influence the learner, or perhaps because the performance history data was somehow skewed. The “explore” option in effect addresses the possibility that the performance history data may be inaccurate (especially at the beginning of the machine learning process, where the amount of performance history data is limited), and thus, correspondingly, the performance prediction may also be imperfect or have a high degree of uncertainty. As the amount of performance history data increases, the performance prediction becomes relatively more accurate/reliable, and thus the need to “explore” may be lessened. Thus, a combination of “exploit” and “explore” steps is considered to be appropriate and optimal.

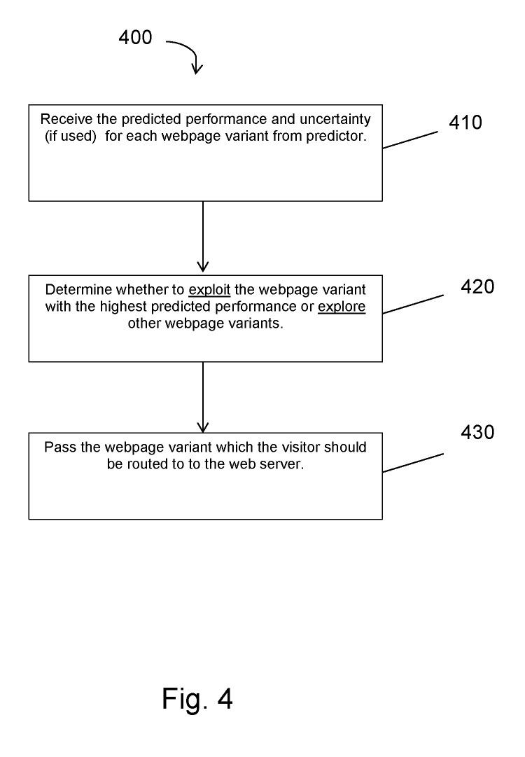

FIG. 4 is a flowchart summarising the overall processing flow 400 for the router. The router receives from the predictor, the predicted performance and uncertainty (if used) for a visitor with respect to each webpage variant (step 410). These inputs are then used to “decide” which webpage variant the visitor should be routed to (step 420), according to an explore/exploit strategy. The methods used to translate the predictor's predictions and uncertainties into a webpage decision may include, but are not limited to, Thompson sampling, epsilon-greedy strategy, epsilon-decreasing strategy, Monte Carlo simulation, and Upper Confidence Bound. For example, when using an epsilon-greedy methodology, the router balances exploration and exploitation using a parameter with a value between 0 and 1 called “epsilon”. For each visitor, the algorithm chooses whether to explore, with probability epsilon, or to exploit, with probability (1−epsilon). If the algorithm decides to exploit, then the visitor is directed to the webpage variant with the highest predicted performance statistic for that visitor as determined by the predictor (based on the visitor's attributes). If the algorithm decides to explore, then the visitor is randomly directed to one of the webpage variants with lower predicted performance statistics. Once the routing decision is made, the decision is passed on to web servers that can then send the appropriate webpage variant to the visitor (step 430).

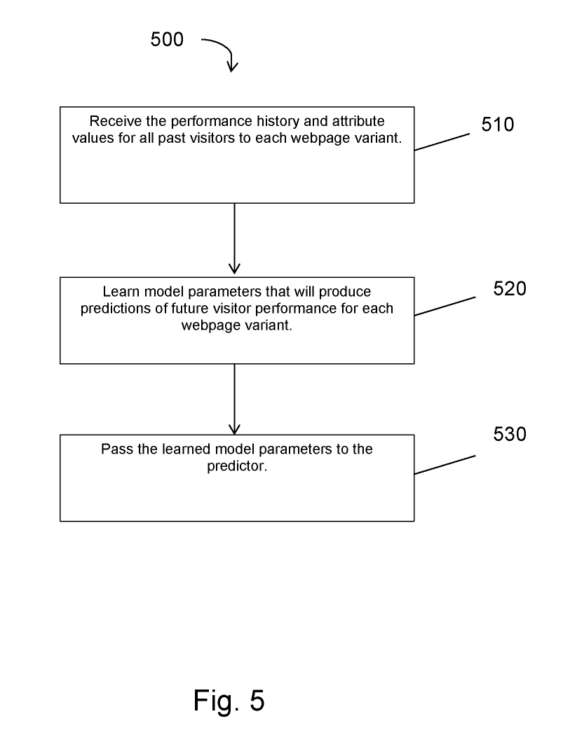

Referring now to the “learner” in more detail, it consists of a machine learning model that learns a predictive model for each individual webpage variant, utilizing a general framework. FIG. 5 is a flowchart illustrating the overall processing flow 500 for the learner. The learner receives the performance history for each webpage variant and the attributes for all past visitors to each webpage variant (step 510). This input may take the form of a complete performance history of visitors to each webpage variant or as an update to a previous performance history already stored by the learner.

The learner then determines parameters for the predictor's predictive model that produce optimal estimates for the webpage variants' performance statistics (step 520). This parameter determination is referred to as ‘learning the model’, and may be accomplished by methods including, but not limited to, Bayesian inference, Maximum Likelihood Estimation, and Stochastic Gradient Descent. Since the learner can update its predictive model after every new visitor (by incorporating the resulting performance statistic for each additional visitor into the performance history), this is also an online process. The learner then passes the learned model parameters to the predictor (step 530) to be applied with respect to the next visitor. For example, if the learner is a Neural Network model utilizing Stochastic Gradient Descent, it would learn the neuron weights based on a set of historical data. The predictor would then be a Neural Network with identical architecture, and would receive these learned weights and use them to make predictions on new, incoming data.

The foregoing method descriptions and the process flow diagrams are provided merely as illustrative examples, and are not intended to require or imply that the steps of the various aspects must be performed in the order presented. As will be appreciated by one of skill in the art, the order of steps in the foregoing aspects may be performed in any order.

In one or more exemplary aspects, the functions described may be implemented in hardware, software, firmware, or any combination thereof. If implemented in software, the functions may be stored as one or more instructions or code on a computer-readable medium. The steps of a method or algorithm disclosed herein may be embodied in a processor-executable software module which may reside on a tangible, non-transitory computer-readable storage medium. Tangible, non-transitory computer-readable storage media may be any available media that may be accessed by a computer.

We claim:

1. A computer-implemented method for routing Internet traffic for a target webpage, wherein the target webpage has a plurality of webpage variants, and wherein the Internet traffic comprises a plurality of new visitors, comprising:
at a server:
(i) receiving a request for the target webpage from a new visitor;
(ii) receiving at least one attribute for said new visitor;
(iii) calculating for each webpage variant, a predicted performance statistic and optionally an uncertainty in relation to the new visitor, based upon the at least one attribute of the new visitor and based upon a performance history for each webpage variant, the performance history including a performance statistic in relation to visitor attributes;
(iv) routing the new visitor to a routed webpage variant, based upon an exploit/explore strategy, wherein the routed webpage variant is one of the webpage variants;
(v) determining an actual performance outcome for the routed webpage variant in respect of the new visitor;
(vi) updating the performance history by incorporating the actual performance outcome for the routed webpage variant in respect of the new visitor and by incorporating the at least one attribute of the new visitor; and
(vii) repeating steps (i) to (vi) for each subsequent new visitor.

2. A computer-implemented method for routing Internet traffic for a target webpage, wherein the target webpage has a plurality of webpage variants, and wherein the Internet traffic comprises a plurality of new visitors, comprising:
at a server:
(i) receiving a request for the target webpage from a new visitor;
(ii) receiving at least one attribute for said new visitor;
(iii) determining for each webpage variant a performance history, the performance history including a performance statistic in relation to visitor attributes;
(iv) calculating for each webpage variant, a predicted performance statistic and optionally an uncertainty in relation to the new visitor, based upon the at least one attribute of the new visitor and based upon the performance history;
(v) routing the new visitor to a routed webpage variant, based upon an exploit/explore strategy, wherein the routed webpage variant is one of the webpage variants;
(vi) determining an actual performance outcome for the routed webpage variant in respect of the new visitor;
(vii) updating the performance history by incorporating the actual performance outcome for the routed webpage variant in respect of the new visitor and by incorporating the at least one attribute of the new visitor; and
(viii) repeating steps (i) to (vii) for each subsequent new visitor.

3. The computer-implemented method of claim 1, wherein the at least one attribute is selected from the group consisting of: visitor device operating system type; desktop or mobile user; visitor browser type; IP address; internet service provider; visitor geographic location; server's geographic location; visitor age demographic; visitor firmographic attribute; visitor browser language; referrer channel; and Urchin Tracking Module parameters.

4. The computer-implemented method of claim 3, wherein the at least one attribute for the new visitor is automatically detected by the server.

5. The computer-implemented method of claim 1, wherein the performance statistic reflects webpage conversion rate.

6. The computer-implemented method of claim 1, wherein the performance statistic reflects webpage click-through rates or user lead generations.

7. The computer-implemented method of claim 1, wherein the predicted performance statistic is calculated using one or more modeling techniques selected from of the group consisting of: Naïve Bayes; Hierarchical Bayes; Neural Networks; Linear Regression; and Regression Trees.

8. The computer-implemented method of claim 1, wherein the uncertainty is calculated using one or more modeling techniques selected from of the group consisting of: Monte Carlo sampling; bootstrapping; and propagation of uncertainty.

9. The computer-implemented method of claim 1, wherein the exploit/explore strategy is determined from using one or more of strategies selected from the group consisting of: Thompson sampling; epsilon-greedy strategy; epsilon-decreasing strategy; Monte Carlo simulation and Upper Confidence Bound.

10. The computer-implemented method of claim 1, wherein the exploit/explore strategy involves maximising the predicted performance statistic.

11. The computer-implemented method of claim 1, wherein the step of calculating for each webpage variant a predicted performance statistic and an optionally uncertainty in relation to the new visitor, is additionally calculated based on a plurality of learned model parameters; and wherein the step of updating the performance history by incorporating the actual performance outcome for the routed webpage variant in respect of the new visitor and by incorporating the at least one attribute of the new visitor additionally comprises: determining the learned model parameters for each webpage variant.

12. The computer-implemented method of claim 11, wherein the determining the learned model parameters is performed by a modelling method selected from the group consisting of Bayesian Inference, Maximum Likelihood Estimation and Stochastic Gradient Descent.

13. A communication system for routing Internet traffic for a target webpage, wherein the target webpage has a plurality of webpage variants, and wherein the Internet traffic comprises a plurality of new visitors, the system comprising:
a web-based communication network;
a plurality of communication devices coupled to the communication network; and
a server coupled to the communication network, wherein the server comprises a processor configured with executable instructions to perform operations comprising:
at the server:
(i) receiving a request for the target webpage from a new visitor;
(ii) receiving at least one attribute for said new visitor;
(iii) calculating for each webpage variant, a predicted performance statistic and optionally an uncertainty in relation to the new visitor, based upon the at least one attribute of the new visitor and based upon a performance history for each webpage variant, the performance history including a performance statistic in relation to visitor attributes;
(iv) routing the new visitor to a routed webpage variant, based upon an exploit/explore strategy, wherein the routed webpage variant is one of the webpage variants;
(v) determining an actual performance outcome for the routed webpage variant in respect of the new visitor;
(vi) updating the performance history by incorporating the actual performance outcome for the routed webpage variant in respect of the new visitor and by incorporating the at least one attribute of the new visitor; and
(vii) repeating steps (i) to (vi) for each subsequent new visitor.

14. A non-transitory computer readable storage medium having stored thereon processor-executable instructions configured to cause a processor to perform operations for routing Internet traffic for a target webpage, wherein the target webpage has a plurality of webpage variants, and wherein the Internet traffic comprises a plurality of new visitors, the operations comprising:
at the server:
(i) receiving a request for the target webpage from a new visitor;
(ii) receiving at least one attribute for said new visitor;
(iii) calculating for each webpage variant a predicted performance statistic and an uncertainty in relation to the new visitor, based upon the at least one attribute of the new visitor and based upon a performance history for each webpage variant, the performance history including a performance statistic in relation to visitor attributes;
(iv) routing the new visitor to a routed webpage variant, based upon an exploit/explore strategy, wherein the routed webpage variant is one of the webpage variants;
(v) determining an actual performance outcome for the routed webpage variant in respect of the new visitor;
(vi) updating the performance history by incorporating the actual performance outcome for the routed webpage variant in respect of the new visitor and by incorporating the at least one attribute of the new visitor; and
(vii) repeating steps (i) to (vi) for each subsequent new visitor.
